(19) United States
(12) Patent Application Publication
(10) Pub. No.: US 2024/0170962 A1
(43) Pub. Date: May 23, 2024

(54) System and Method for Lowering the Associated Carbon Emissions of Data Centers Through Power Generated by Low, Neutral, and/or Negative Carbon Intensity Hydrogen

(71) Applicant: Kraken Technology Holdings, LLC, Houston, TX (US)

(72) Inventors: Christopher Michael Miller, Richmond, TX (US); Anna Louise Buckley, Houston, TX (US); Byron Gladus Best, III, Katy, TX (US); John Edwin Plumlee, Katy, TX (US); Bengt Arne Jarlsjo, Houston, TX (US); Daniel Joseph Shapiro, Houston, TX (US)

(21) Appl. No.: 18/325,624

(22) Filed: May 30, 2023

Related U.S. Application Data
(63) Continuation-in-part of application No. 18/117,606, filed on Mar. 6, 2023, now Pat. No. 11,952,276.
(60) Provisional application No. 63/451,940, filed on Mar. 14, 2023.
(60) Provisional application No. 63/482,430, filed on Jan. 31, 2023.
(60) Provisional application No. 63/427,258, filed on Nov. 22, 2022.
(60) Provisional application No. 63/409,331, filed on Sep. 23, 2022.

(51) Int. Cl. H02J 3/00

(52) U.S. Cl. CPC H02J 3/004; H02J 2300/30

(57) ABSTRACT

A method for operating a data center with a carbon usage effectiveness less than 0.1 kg CO₂e/kWh is provided. At least some of the required power for the data center is generated from hydrogen having a carbon intensity preferably less than about 1.0 kg CO₂e/kg H₂, wherein a hydrocarbon feedstock is converted to the hydrogen using a hydrogen production process, wherein at least some of the required energy for the hydrogen production process is provided from a biomass power plant. Also provided is a method for operating a data center with a carbon usage effectiveness less than 0.05 kg CO₂e/kWh, wherein at least some of the required power for the data center is generated from hydrogen having a carbon intensity less than about 0.45 kg CO₂e/kg H₂. Also provided is a method for operating a data center with a carbon usage effectiveness less than 0.0 kg CO₂e/kWh, wherein at least some of the required power for the data center is generated from hydrogen having a carbon intensity less than about 0.0 kg CO₂e/kg H₂.

### CROSS-REFERENCE TO RELATED APPLICATIONS

This application claims the benefit of U.S. Prov. App. Nos. 63/451,940 (filed Mar. 14, 2023), 63/482,430 (filed Jan. 31, 2023), 63/427,258 (filed Nov. 22, 2022), and U.S. application Ser. No. 18/118,553 (filed Mar. 7, 2023), which is a continuation of U.S. application Ser. No. 18/117,606 (filed Mar. 6, 2023), which claims the benefit of U.S. Prov. App. No. 63/409,331 (filed Sep. 23, 2022), all of which are incorporated by reference herein in their entireties.

### BACKGROUND

The present invention relates to a method and process for lowering the carbon intensity of power and auxiliaries required for data center operations. The process includes a method where hydrogen, specifically produced through reforming of a hydrocarbon feed or through electrolysis of water using dispatchable biomass energy, can be utilized to reduce the carbon usage effectiveness of the data center.

Data centers are buildings that centralize computer and/or information technology (IT) systems. Organizations use data centers for the management of data processing, data storage, and more. The physical site for a data center often bears large electrical loads due to the significant computing requirements of the IT systems and equipment. Data centers also require large cooling loads, typically from a mechanical chilling system that also consumes electricity, to reject the heat generated from the IT systems and equipment. Both these electrical and cooling loads require an energy source to operate.

Today, data centers are estimated to account for approximately 1.0 to 1.5% of the current global electricity demand and account for nearly 0.9% of energy-related greenhouse gas (GHG) emissions or 0.6% of the total GHG emissions.

The data center market is estimated to grow at an annual rate above 10% a year until 2030. As the data center market continues to grow with increased global computing demand, it is critical to lower the carbon emissions associated with data center operations.

A data center's associated carbon emissions are measured by its carbon usage effectiveness (CUE), which is defined as the total equivalent carbon dioxide emissions divided by the energy consumption of the data center's IT equipment. CUE is frequently rated in kilograms of equivalent carbon dioxide per kilowatt-hour of energy demand (kg CO₂e/kWh).

The CUE can alternatively be calculated by multiplying the data center's power usage effectiveness (PUE) by the carbon emissions factor of the regional grid electricity. PUE is the ratio of the total amount of power used by the data center divided by the energy consumption of the data center's IT equipment. A theoretical PUE ratio of 1.0 indicates that all the facility's power is dedicated to the IT equipment indicating that no power is supplied to the data center's lighting or auxiliary equipment (i.e. cooling).

Sources of carbon emissions associated with the data center's CUE include emissions associated with the production of imported power for the operation of the data center as defined by the carbon emissions factor of the regional grid electricity. Assuming a minimum theoretical PUE of 1.0 and an average U.S. grid electricity mix of 465 kg CO₂e/MWh, the CUE of the data center would be 0.47 kg CO₂e/kWh.

As the global economy drives toward environmental, social, and governance (ESG) solutions, data centers must seek solutions to decrease their CUE and eventually target a CUE of 0.0 kg CO₂e/kWh. In order to achieve this reduction in the CUE, low carbon intensity power sources must be considered. Commercially available options for low or neutral carbon intensity power currently include solar, wind, nuclear, and/or hydro power.

Solar, wind, and hydro energy for powering data centers are challenged by location, variable load generation, and cost. Data centers consume a relatively constant amount of power, while the generation of solar and wind energy varies over time, which creates the need for expensive energy storage solutions. Battery storage can be cost prohibitive and difficult to scale. Hydropower can also be subject to fluctuations due to changes in weather patterns that lead to droughts or flooding. Furthermore, a data center may be geographically remote from sufficient wind, solar, or hydro power sources. Regional capacity factors may also limit large scale production of power for use in data centers.

Hydrogen is widely considered a strong alternative as a decarbonized energy carrier to reduce the carbon footprint of many industries, including power generation. Because hydrogen does not contain a carbon molecule, it produces water and not carbon dioxide upon combustion. In order to result in a net reduction of carbon emissions and a reduction to a data center's CUE, low and/or neutral carbon intensity hydrogen must be utilized to provide power to data centers.

Hydrogen carbon intensity may be evaluated using a life cycle analysis methodology such as Argonne National Laboratory's Greenhouse Gases, Regulated Emissions, and Energy Use in Technologies Model (GREET). The term “carbon intensity” refers to a measure of the amount of equivalent carbon dioxide (CO₂e) emitted to produce a specified amount of a product, such as hydrogen. CO₂e is a common unit used to sum various greenhouse gases based on their global warming potential (GWP). Hydrogen carbon intensity is frequently rated in kilograms of equivalent carbon dioxide per kilogram of hydrogen (kg CO₂e/kg H₂).

The present invention provides a solution for reducing the CUE of data centers using low, neutral and/or negative carbon intensity hydrogen, which is produced through reforming of hydrocarbon feedstock or through electrolysis of water using dispatchable biomass energy, to produce low or neutral carbon power.

### SUMMARY OF THE INVENTION

A method for operating a data center with a carbon usage effectiveness less than 0.1 kg CO₂e/kWh is provided. At least some of the required power for the data center, and preferably substantially all of the required power for the data center, is generated from hydrogen having a carbon intensity preferably less than about 1.0 kg CO₂e/kg H₂, more preferably less than 0.45 kg CO₂e/kg H₂, and most preferably less than about 0.0 kg CO₂e/kg H₂, wherein a hydrocarbon feedstock is converted to the hydrogen using a hydrogen production process. At least some of the required energy for the hydrogen production process, and preferably substantially all of the required energy for the hydrogen production process, is provided from a biomass power plant. One or more gas streams containing carbon dioxide from the biomass power plant and the hydrogen production process can be processed in one or more carbon capture units to reduce CO₂e emissions. At least some of the required power for the data center can be generated by combusting the hydrogen in a gas turbine, either in a simple cycle configuration, a combined cycle configuration, or a cogeneration configuration. At least some of the required power for the data center can be generated by an electrochemical process using the hydrogen in a fuel cell. At least some of the required power for the data center can be generated by a combination of combusting the hydrogen in a gas turbine and through an electrochemical process using hydrogen in a fuel cell, wherein water produced from the fuel cell is used as diluent to the gas turbine.

The present invention is also directed to a method for operating a data center with a carbon usage effectiveness less than 0.05 kg CO₂e/kWh, wherein at least some of the required power for the data center is generated from hydrogen having a carbon intensity less than about 0.45 kg CO₂e/kg H₂.

The present invention is also directed to a method for operating a data center with a carbon usage effectiveness less than 0.0 kg CO₂e/kWh, wherein at least some of the required power for the data center is generated from hydrogen having a carbon intensity less than about 0.0 kg CO₂e/kg H₂.

### DESCRIPTION OF FIGURES

The features and advantages of the present invention will be more clearly understood from the following description taken in conjunction with the accompanying drawings in which:

FIG. 1 depicts a process flow diagram for producing electricity for a data center using low, neutral and/or negative carbon intensity hydrogen as fuel for a simple cycle turbine.

FIG. 2 depicts a process flow diagram for producing electricity for a data center using low, neutral and/or negative carbon intensity hydrogen as fuel for a combined cycle turbine.

FIG. 3 depicts a process flow diagram for the process of FIG. 2, in which steam is extracted from the turbine to produced chilled water in an adsorption chiller for use in a data center.

FIG. 4 depicts a process flow diagram for producing electricity for a data center using low, neutral and/or negative carbon intensity hydrogen as fuel for a fuel cell.

### DETAILED DESCRIPTION OF THE INVENTION

The present invention relates to a method and process for reducing the carbon usage effectiveness of data centers to preferably less than about 0.1 kg CO₂e/kWh, more preferably less than 0.05 kg CO₂e/kWh, and most preferably less than 0.0 kg CO₂e/kWh, using electricity generated from low, neutral and/or negative carbon intensity hydrogen.

In all embodiments of the present invention described herein, the low, neutral, and/or negative carbon intensity hydrogen is produced according to the teachings of commonly owned U.S. application Ser. No. 18/117,606 (filed Mar. 6, 2023), which is incorporated by reference herein in its entirety. As discussed therein, the energy for the hydrogen production process is provided by the combustion or gasification of various forms of biomass to reduce the carbon intensity of the hydrogen product to preferably less than 1.0 kg CO₂e/kg H₂, more preferably less than 0.45 kg CO₂e/kg H₂, and most preferably less than 0.0 kg CO₂e/kg H₂.

In all embodiments of the present invention described herein, the low, neutral, and/or negative carbon intensity hydrogen is produced according to the teachings of commonly owned U.S. Prov. App. Nos. 63/451,940 (filed Mar. 14, 2023), which is incorporated by reference herein in its entirety. As discussed therein, the energy to produce hydrogen through electrolysis is provided by an integrated biomass energy plus carbon capture to reduce the carbon intensity of the hydrogen product to preferably less than 0.45 kg CO₂e/kg H₂ and more preferably less than 0.0 kg CO₂e/kg H₂.

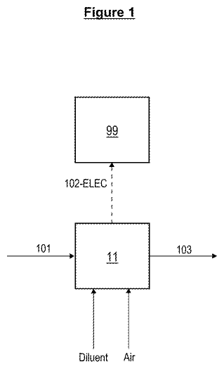

With reference to FIG. 1, a first embodiment of the present invention is depicted, in which carbon neutral or carbon negative electricity can be produced by a simple cycle gas turbine. The low, neutral, and/or negative carbon intensity hydrogen feedstock 101 is sent to gas turbine 11. The hydrogen is mixed with air and/or a diluent, typically consisting of steam, water, or nitrogen, and is combusted in gas turbine 11, configured in a simple cycle, utilizing a Brayton cycle to generate carbon neutral or carbon negative electricity 102-ELEC to power data center 99. Turbine exhaust 103 is vented to atmosphere.

Turbine 11 can be configured as either a wet low NOₓ (WLN) combustor (i.e. diffusion type) or a dry low NOₓ (DLN) combustor (i.e. lean-premix type). Where the turbine combustor specified is a WLN, the hydrogen fuel is mixed with a diluent, typically consisting of steam, water, or nitrogen, to reduce the adiabatic flame temperature and therefore reduce the formation of nitrous oxides (NOₓ) in the turbine exhaust.

The combustion air can be chilled prior to mixing with hydrogen fuel 101 to increase the efficiency of the turbine, not shown.

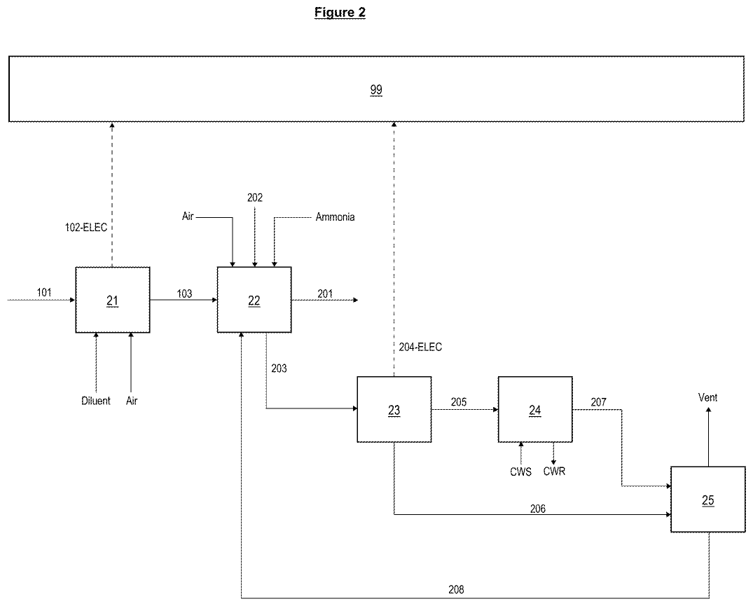

In a second embodiment of the present invention, FIG. 2 illustrates producing carbon neutral or carbon negative electricity for a data center using a combined cycle gas turbine. Similar to FIG. 1, the low, neutral, and/or negative carbon intensity hydrogen 101 is sent to gas turbine 21. Hydrogen 101 is mixed with air and/or a diluent, typically consisting of steam, water, or nitrogen, and is combusted utilizing a Brayton cycle to generate carbon neutral or carbon negative electricity 102-ELEC to power data center 99. Turbine exhaust 103 is sent to heat recovery steam generator (HRSG) 22, and the cooled turbine exhaust 201 is vented to the atmosphere.

Superheated steam 203 is produced in HRSG 22 from the waste heat from turbine exhaust 103. Superheated steam 203 is sent to steam turbine 23, in which additional carbon neutral or carbon negative electricity 204-ELEC is produced by a Rankine cycle to power data center 99. Steam turbine exhaust 205 is condensed in surface condenser 24, and condensate 207 is sent to deaerator 25.

As depicted in FIG. 2, surface condenser 24 is preferably configured to utilize a cooling water system to condense the steam turbine exhaust. The heat from the steam turbine exhaust is transferred to the cooling water, which is typically sent to an evaporative cooling tower where the heat is exchanged against ambient air. The cooled cooling water is circulated back to surface condenser 24. The cooling water can also be used as a cooling medium for the servers, air handling units, and/or the heating, ventilation, and air conditioning (HVAC) systems of the data centers.

Deaerator stripping steam 206 is extracted from steam turbine 23. Steam can also be extracted from steam turbine 23 for beneficial use external to the process (e.g. district heating), not shown. Boiler feed water 208 from deaerator 25 is sent to HRSG 22 to produce superheated steam 203.

HRSG 22 can also be configured to be duct fired with hydrogen 202 and air to produce additional superheated steam and thus generate additional electricity.

Emissions controls, such as a selective catalytic reduction (SCR) which requires ammonia injection, can also be added to HRSG 22 to treat the turbine exhaust prior to being vented to the atmosphere.

Similar to FIG. 1, turbine 21 can be configured with WLN or DLN combustors, and the combustion air can also be chilled to increase the efficiency of the turbine.

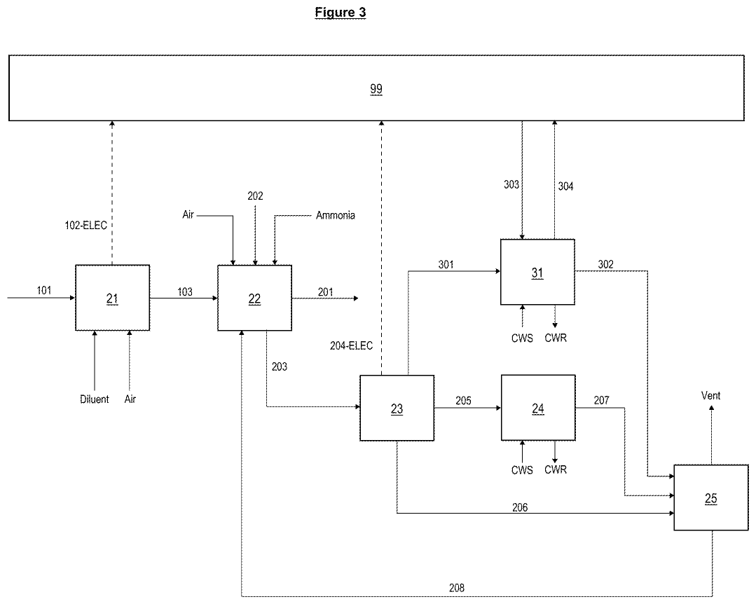

In a third embodiment of the present invention, FIG. 3 illustrates a similar combined cycle gas turbine to produce carbon neutral or carbon negative electricity 102-ELEC and 204-ELEC to power data center 99 as depicted in FIG. 2; however, FIG. 3 also demonstrates the use of an absorption chiller 31 to provide the chilling duty required for the servers, air handling units, or the HVAC systems of data center 99.

Similar to FIG. 2, superheated steam 203 is produced in HRSG 22 and is sent to steam turbine 23 to produce carbon neutral or carbon negative electricity 204-ELEC to power data center 99. Steam 301 is extracted from steam turbine 23 and sent to absorption chiller 31. The heat from the steam is used to drive an evaporation and condensation process that transfers heat from a chilled water system to a cooling water system. Chilled water supply 304 can be used to provide the chilling duty for data center 99 servers either directly, as a liquid cooling medium, or indirectly, as a cooling medium for the immersion circulation fluid. Chilled water return 303 is circulated back to absorption chiller 31 to remove the heat generated from the data center servers. The chilled water can also be used to provide the chilling duty for the air handling and/or HVAC systems to cool the data center building. Condensed steam 302 from the absorption chiller is sent to deaerator 25 along with condensate 207.

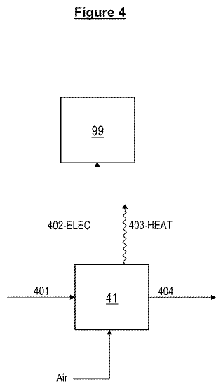

In a fourth embodiment of the present invention, FIG. 4 illustrates producing carbon neutral or carbon negative electricity 402-ELEC for a data center 99 using a fuel cell 41. Low, neutral, and/or negative carbon intensity hydrogen 401 is sent to fuel cell 41 where electricity 402-ELEC is generated by an electrochemical process. In the electrochemical process, hydrogen 401 is converted into water 404 in the presence of air. Air acts as an oxidizing agent in the electrochemical process.

Water 404 produced from the electrochemical reaction can be used as makeup water to the evaporative cooling tower, HVAC systems for data center 99, and/or beneficial use external to the process.

The fuel cell also produces a high-grade waste heat byproduct 403-HEAT than can be used external to the process (e.g. district heating). The high-grade waste heat byproduct 403-HEAT can also be used to heat the steam or water of an adsorption chiller to provide the chilling duty required for the servers, air handling units, or the HVAC systems of data center 99, not shown.

Although not shown, the carbon neutral or carbon negative electricity for the data centers can be produced from a combination of simple cycle, combined cycle, and/or cogeneration turbines and fuel cells. In this configuration the water produced from the electrochemical process can be used as diluent for the WLN combustors or as makeup water to the evaporative cooling tower and/or HVAC systems.

In yet another embodiment, the present invention is directed to a method for operating a data center with a carbon usage effectiveness less than 0.1 kg CO₂e/kWh. The method includes providing at least some of the required power for the data center, and preferably substantially all of the required power for the data center, from power generated from hydrogen having a carbon intensity preferably less than about 1.0 kg CO₂e/kg H₂, more preferably less than 0.45 kg CO₂e/kg H₂, and most preferably less than about 0.0 kg CO₂e/kg H₂, wherein a hydrocarbon feedstock is converted to the hydrogen using a hydrogen production process. At least some of the required energy for the hydrogen production process, and preferably substantially all of the required energy for the hydrogen production process, is provided from a biomass power plant. One or more gas streams containing carbon dioxide from the biomass power plant and the hydrogen production process can be processed in one or more carbon capture units to reduce CO₂e emissions. At least some of the required power for the data center can be generated by combusting the hydrogen in a gas turbine, either in a simple cycle configuration, a combined cycle configuration, or a cogeneration configuration. The method includes providing chilling duty to one or more data center servers, air handling units, or HVAC systems, wherein the chilling duty is provided by an absorption chiller that uses steam or water heated by the gas turbine exhaust. At least some of the required power for the data center can be generated by an electrochemical process using the hydrogen in a fuel cell. The method includes providing chilling duty to the data center servers, air handling units, or HVAC system, wherein the chilling duty is provided by an absorption chiller that uses steam or water heated by a high-grade waste heat byproduct generated by the fuel cell. Water produced from the fuel cell can be used as makeup water to one or more cooling towers or HVAC systems for the data center. At least some of the required power for the data center can be generated by a combination of combusting the hydrogen in a gas turbine and through an electrochemical process using hydrogen in a fuel cell, wherein water produced from the fuel cell is used as diluent to the gas turbine.

In yet another embodiment, the present invention is directed to a method for operating a data center with a carbon usage effectiveness less than 0.05 kg CO₂e/kWh, wherein at least some of the required power for the data center is generated from hydrogen having a carbon intensity less than about 0.45 kg CO₂e/kg H₂.

In yet another embodiment, the present invention is directed to a method for operating a data center with a carbon usage effectiveness less than 0.0 kg CO₂e/kWh, wherein at least some of the required power for the data center is generated from hydrogen having a carbon intensity less than about 0.0 kg CO₂e/kg H₂.

A data center that uses an average U.S. grid electricity mix of 465 kg CO₂e/MWh, has a CUE of 0.47 kg CO₂e/kWh. Even with the lowest achievable U.S. grid electricity mix of 167 kg CO₂e/MWh in 2022 per GREET, the data center will have a CUE greater than 0.17 kg CO₂e/kWh. Table 1 below depicts a data center CUE with natural gas (for reference) and hydrogen fuels for both a simple cycle and combined cycle gas turbine.

TABLE 1

| | | | Data Center CUE | |
|---|---|---|---|---|
| | | | Simple Cycle | Combined Cycle |
| Source of Electricity | Basis | | kg CO2e/kWh | kg CO2e/kWh |
| Natural Gas | 13,724 | g CO₂e/MMBTU (LHV) | 0.58 | 0.39 |
| Certified Natural Gas | 7,500 | g CO₂e/MMBTU (LHV) | 0.53 | 0.36 |
| Hydrogen (Reforming) | 10.0 | kg CO₂e/kg H₂ | 0.69 | 0.47 |
| Hydrogen (Reforming) with | 4.0 | kg CO₂e/kg H₂ | 0.28 | 0.19 |
| Carbon Capture | | | | |
| Hydrogen (Reforming) with | 2.5 | kg CO₂e/kg H₂ | 0.17 | 0.12 |
| Carbon Capture and | | | | |
| Certified Natural Gas | | | | |
| Hydrogen* | 1.0 | kg CO₂e/kg H₂ | 0.07 | 0.05 |
| Hydrogen** | 0.45 | kg CO₂e/kg H₂ | 0.03 | 0.02 |
| Hydrogen** | 0.0 | kg CO₂e/kg H₂ | 0.0 | 0.0 |

*Hydrogen produced through hydrocarbon reforming with integrated biomass energy plus carbon capture and sequestration
**Hydrogen produced through hydrocarbon reforming with integrated biomass energy plus carbon capture and sequestration and/or electrolysis with integrated biomass energy plus carbon capture and sequestration

The low or neutral carbon intensity power to reduce the CUE of a data center to less than 0.1 kg CO₂e/kWh can be provided by low, neutral and/or negative carbon intensity hydrogen, via reforming of a hydrocarbon feedstock or through electrolysis of water using dispatchable biomass energy.

Therefore, the present invention is well adapted to attain the ends and advantages mentioned as well as those that are inherent therein. The particular embodiments disclosed above are illustrative only, as the present invention may be modified and practiced in different but equivalent manners apparent to those skilled in the art having the benefit of the teachings therein. It is therefore evident that the particular embodiments disclosed above may be altered or modified and all such variations are considered within the scope and spirit of the present invention.

What is claimed is:

1. A method for operating a data center with a carbon usage effectiveness less than 0.1 kg CO₂e/kWh, comprising:
providing at least some of the required power for the data center from power generated from hydrogen having a carbon intensity less than about 1.0 kg CO₂e/kg H₂, wherein the hydrogen is produced using a hydrogen production process, wherein at least some of the required energy for the hydrogen production process is provided from a biomass power plant.

2. The method of claim 1, wherein the hydrogen production process comprises converting a hydrocarbon feedstock to hydrogen using a hydrocarbon reforming process.

3. The method of claim 1, wherein the hydrogen production process comprises electrolysis of water to produce hydrogen.

4. The method of claim 2, wherein one or more gas streams containing carbon dioxide from the biomass power plant and the hydrogen production process are processed in one or more carbon capture units to reduce CO₂e emissions.

5. The method of claim 3, wherein one or more flue gas streams containing carbon dioxide from the biomass power plant are processed in one or more carbon capture units to reduce CO₂e emissions.

6. The method of claim 1, wherein substantially all of the required energy for the hydrogen production process is provided from a biomass power plant.

7. The method of claim 1, wherein the hydrogen has a carbon intensity less than about 0.45 kg CO₂e/kg H₂.

8. The method of claim 1, wherein the hydrogen has a carbon intensity less than about 0.0 kg CO₂e/kg H₂.

9. The method of claim 1, further comprising providing substantially all the required power for the data center from the hydrogen.

10. The method of claim 1, wherein at least some of the required power for the data center is generated by combusting the hydrogen in a gas turbine.

11. The method of claim 10, wherein the gas turbine is in a simple cycle configuration.

12. The method of claim 10, wherein the gas turbine is in a combined cycle configuration.

13. The method of claim 10, wherein the gas turbine is in a cogeneration configuration.

14. The method of claim 10, further comprising providing chilling duty to one or more data center servers, air handling units, or HVAC systems, wherein the chilling duty is provided by an absorption chiller that uses steam or water heated by the gas turbine exhaust.

15. The method of claim 1, wherein at least some of the required power for the data center is generated by an electrochemical process using the hydrogen in a fuel cell.

16. The method of claim 15, further comprising providing chilling duty to the data center servers, air handling units, or HVAC system, wherein the chilling duty is provided by an absorption chiller that uses steam or water heated by a high-grade waste heat byproduct generated by the fuel cell.

17. The method of claim 15, wherein water produced from the fuel cell is used as makeup water to one or more cooling towers or HVAC systems for the data center.

18. The method of claim 1, wherein at least some of the required power for the data center is generated by a combination of combusting the hydrogen in a gas turbine and through an electrochemical process using hydrogen in a fuel cell.

19. The method of claim 18, wherein water produced from the fuel cell is used as diluent to the gas turbine.

20. The method of claim 1, wherein the data center has a carbon usage effectiveness less than 0.05 kg CO₂e/kWh.

21. The method of claim 20, wherein at least some of the required power for the data center is generated from hydrogen having a carbon intensity less than about 0.45 kg CO₂e/kg H₂.

22. The method of claim 1, wherein the data center has a carbon usage effectiveness less than 0.0 kg CO₂e/kWh.

23. The method of claim 22, wherein at least some of the required power for the data center is generated from hydrogen having a carbon intensity less than about 0.0 kg CO₂e/kg H₂.
